(19) United States
(12) Patent Application Publication
(10) Pub. No.: US 2014/0215185 A1
(43) Pub. Date: Jul. 31, 2014

(54) FETCHING INSTRUCTIONS OF A LOOP ROUTINE

(71) Applicant: Stein Danielsen, Norway (NO)

(72) Inventor: Stein Danielsen, Norway (NO)

(73) Assignee: Atmel Norway

(21) Appl. No.: 13/753,380

(22) Filed: Jan. 29, 2013

(51) Int. Cl. G06F 9/38

(52) U.S. Cl. CPC G06F 9/38
USPC 712/205

(57) ABSTRACT

In one aspect, a processor is configured to store instructions fetched from a program memory in an instruction queue, determine that an instruction to be decoded defines a beginning of a loop routine, and determine whether the instruction is stored in the instruction queue. In response to determining that the instruction is stored in the instruction queue, the processor disables fetching of instructions from the program memory, fetches instructions of the loop routine from the instruction queue, and stores the instructions of the loop routine in an instruction register. In response to determining that the instruction is not stored in the instruction queue, the processor fetches the instruction from the program memory, stores the instruction in the instruction queue, and stores the instruction in the instruction register.

### TECHNICAL FIELD

This disclosure relates generally to processors and more particularly to instruction caching within such processors.

### BACKGROUND

A processor executes programs, which are typically represented as ordered sequences of instructions. Programs frequently include loop routines. The processor may execute the instructions of the loop routine multiple times during execution of the program. A loop routine may be defined by an instruction that contains syntax reflecting the beginning of the loop routine, such as a “for” or “while” statement. Alternatively, a loop routine may be defined by a branch instruction or a jump instruction that directs program execution to a target instruction that occurs earlier in the instruction sequence.

A processor fetches program instructions from a main program memory, which may be a non-volatile memory. When the processor encounters a loop instruction, the instructions within the loop routine are fetched by the processor for execution, and the same instructions are fetched in subsequent iterations of the loop. Fetching of instructions from the main program memory may always be enabled to be able to provide the instructions as quickly as possible, which enablement consumes a significant amount of the total power of the processing system.

### SUMMARY

In an exemplary implementation, a processor is configured to store instructions fetched from a program memory in an instruction queue, determine that an instruction to be decoded defines a beginning of a loop routine, and determine whether the instruction is stored in the instruction queue. In response to determining that the instruction is stored in the instruction queue, the processor disables fetching of instructions from the program memory, fetches instructions of the loop routine from the instruction queue, and stores the instructions of the loop routine in an instruction register. In response to determining that the instruction is not stored in the instruction queue, the processor fetches the instruction from the program memory, stores the instruction in the instruction queue, and stores the instruction in the instruction register.

Particular implementations disclosed herein provide one or more of the following advantages. Storing instructions fetched from a program memory in an instruction queue decreases latency of processing instructions of a loop routine by allowing faster access to the instructions of the loop routine. Disabling the fetching of instructions from a main program memory during the processing of instructions of a loop routine from an instruction queue reduces the power consumed by the processing system because there is no unnecessary fetching of instructions from the program memory.

### DESCRIPTION OF DRAWINGS

FIG. 1 is a block diagram of an example of a processor with an instruction fetch controller.

FIG. 2 is a flowchart of examples of operations performed when fetching loop instructions.

### DETAILED DESCRIPTION

Various implementations of the present disclosure are discussed below in conjunction with an example of a processor. A processor may include any device in which instructions retrieved from a memory or other storage element are executed using one or more execution units. Examples of processors may therefore include microprocessors, central processing units (CPUs), very long instruction word (VLIW) processors, single-issue processors, multi-issue processors, digital signal processors, application-specific integrated circuits (ASICs), and other types of data processing devices. The systems and techniques described herein are generally applicable to any processor or processing system in which it is desirable to detect and execute loop instructions so as to reduce the power consumed by the processing system and to improve performance of the processor.

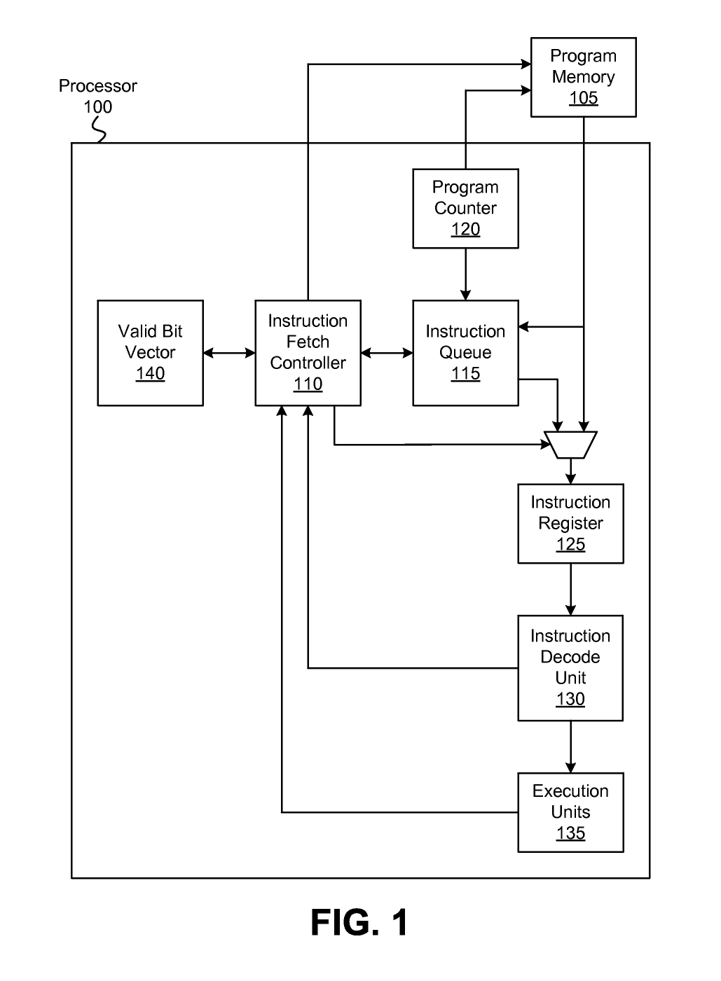

FIG. 1 is a block diagram of a processor 100. The processor 100 may be configured to execute instructions stored in the program memory 105. The processor 100 may utilize an instruction fetch controller 110 to control the fetching of instructions of a loop routine from the program memory 105 or an instruction queue 115. The processor 100 may include a program counter 120, an instruction register 125, an instruction decode unit 130, and execution units 135.

The program counter 120 may be a register that stores a memory address of an instruction. In some implementations, the processor 100 may increment the program counter 120 after an instruction is fetched from the program memory 105, and the program counter 120 stores the memory address of the next instruction that is to be executed. In some implementations, the processor 100 may increment the program counter 120 before an instruction is fetched from the program memory 105, and the program counter 120 stores the memory address of the current instruction that is being executed.

The instruction decode unit 130 decodes the instruction stored in the instruction register 125, which may include determining the operation that is to be performed and determining the address of the operands. The instruction decode unit 130 may provide the decoded instructions to the execution units 135, which performs mathematical and logical operations on the operands. Execution units 135 may include an arithmetic logic unit (ALU), a memory management unit (MMU), an integer unit, a floating point unit, a branch unit, a multiplication unit, a division unit, and other functional units that perform operations or calculations on data.

The instruction queue 115 may be a high speed cache memory or content addressable memory (CAM) (also referred to as associative memory). The instruction queue 115 may include a number of entries, or storage locations, N that are used to store instructions that are fetched from the program memory 105. Each entry may include an instruction field for storing an instruction and an instruction address field for storing a memory address associated with the instruction. The instruction queue 115 may contain, for example, 16 entries. However, the instruction queue 115 may contain any number of entries. For example, the instruction queue 115 may contain a number of entries that is determined to accommodate 95% of all loop sizes.

The instruction queue 115 temporarily stores the last N instructions that are fetched from the program memory 105. The instructions stored in the instruction queue 115 may include executed instructions and skipped instructions. A skipped instruction is an instruction that is not executed, or skipped, as a result of a branch or jump that skips over the instruction in the program sequence.

The valid bit vector 140 is a vector of valid bits. The valid bit vector 140 has a length that is equal to the number of entries N of the instruction queue 115. When an instruction that is to be executed is fetched from the program memory 105, the instruction is stored in the instruction queue 115 and a valid bit of the valid bit vector 140 is set to indicate that the instruction is valid. For example, when an instruction that is to be executed is fetched from the program memory 105 and stored as the first word of the instruction queue 115, the first valid bit of the valid bit vector 140 is set to indicate that the instruction is valid. When a subsequent instruction is fetched from the program memory 105, the valid bits of the valid bit vector 140 are shifted by one position. If the subsequent instruction is to be executed, the first valid bit of the valid bit vector 140 is set to indicate that the instruction is valid. If the subsequent instruction is to be skipped, the first valid bit of the valid bit vector 140 is not set to indicate that the instruction is invalid. In such an implementation, the first valid bit corresponds to the newest instruction fetched from the program memory 105 and stored in the instruction queue 115.

When the instruction queue 115 is full, the fetched instructions may be stored in the instruction queue 115 according to a first in, first out (FIFO) principle. For example, when an instruction is fetched from the program memory 105, the instruction that has been stored in the instruction queue 115 for the longest amount of time is removed from the instruction queue 115 to allow the fetched instruction to be stored in the instruction queue 115. To store the fetched instructions according to the FIFO principle, a write pointer may be used to indicate the instruction that has been stored in the instruction queue 115 for the longest amount of time.

The instruction fetch controller 110 determines whether the next instruction to be decoded defines the beginning of a loop routine. The beginning of a loop routine may be defined by an instruction that contains syntax reflecting the beginning of the loop routine, such as a “for” or “while” statement. Alternatively, a loop routine may be defined by a branch instruction or a jump instruction having a target instruction that occurs earlier in the program sequence. The target instruction is the first instruction of the loop routine, and the branch or jump instruction is the last instruction of the loop routine. Since the branch instruction or jump instruction defines the loop by directing program execution to the target instruction that occurs earlier in the sequence, the target instruction may not itself indicate that it is the first instruction of the loop.

Whether a branch is taken or not taken is typically not determined until an execution unit 135 has executed the branch instruction. Furthermore, the address of the target instruction associated with the branch instruction may not be known until the branch instruction is executed. In those instances, the execution unit 135 may provide the instruction fetch controller 110 with information relating to the outcome of the branch instruction and the address of the target instruction so that the instruction fetch controller 110 can detect whether the next instruction to be decoded defines the beginning of a loop routine.

When the instruction fetch controller 110 determines that the next instruction to be decoded defines the beginning of a loop routine, the instruction fetch controller 110 determines whether the instruction is stored in the instruction queue 115. In some implementations, the instruction fetch controller 110 may determine whether the instruction is stored in the instruction queue 115 by checking the valid bit vector 140. For example, if the next instruction is a target instruction that occurs earlier in the program sequence, the instruction fetch controller 110 may receive an offset value M indicating the offset of the target instruction from a branch or jump instruction. The instruction fetch controller 110 checks the valid bit at the M position of the valid bit vector 140. If the valid bit at the M position is not set, the instruction is not stored in the instruction queue 115. If the valid bit at the M position is set, the instruction is stored in the instruction queue 115.

In some implementations, the instruction fetch controller 110 may determine whether the instruction is stored in the instruction queue 115 by searching the entire contents of the instruction queue 115 in a single operation to identify an entry, if any, associated with the instruction defining the beginning of the loop routine. The instruction queue 115 may receive the memory address of the next instruction from the instruction fetch controller 110 or the program counter 120 and compare the received memory address with the memory addresses specified in the entries of the instruction queue 115. If the received memory address does not match any memory addresses specified in the entries of the instruction queue 115, the instruction is not stored in the instruction queue 115. If the received memory address matches a memory address specified in an entry of the instruction queue 115, the instruction is stored in the instruction queue 115.

If the instruction is not stored in the instruction queue 115, a miss has occurred. A miss may occur when, for example, the number of instructions in the loop routine is greater than the number of entries in the instruction queue 115. When a miss occurs, the instruction fetch controller 110 determines that the instruction defining the beginning of the loop routine is not stored in the instruction queue 115. The instruction is fetched from the program memory 105 and stored in the instruction queue 115 and the instruction register 125. Because the instruction defining the beginning of the loop routine is not stored in the instruction queue 115, each instruction of the loop routine is fetched from the program memory 105 and stored in the instruction queue 115 and the instruction register 125.

If the instruction is stored in the instruction queue 115, a hit has occurred. A hit occurs when the number of instructions in the loop routine is less than or equal to the number of entries in the instruction queue 115. When a hit occurs, the instruction fetch controller 110 determines that the instructions of the loop routine are stored in the instruction queue 115.

In some implementations, the instruction fetch controller 110 may determine from the instructions of the loop routine the information needed to control the fetching of the instructions of the loop routine. The information may include the number of instructions in the loop routine and the number of iterations of the loop routine. When the instructions of the loop routine is present in the instruction queue 115 and the number of iterations of the loop routine is known, or the starting and ending points in the loop routine are known, the instructions of the loop routine may be fetched from the instruction queue 115.

In some implementations, the instruction fetch controller 110 may check the valid bit vector 140 before fetching each instruction of the loop routine from the instruction queue 115. If the valid bit that corresponds to the instruction to be fetched is set, the instruction fetch controller 110 fetches the instruction from the instruction queue 115. If the valid bit that corresponds to the instruction to be fetched is not set, the instruction fetch controller 110 fetches the instruction from the program memory 105.

When the instructions forming the loop routine are available from the instruction queue 115, there is no need to fetch instructions from the program memory 105, and the fetching of instructions from the program memory 105 may be disabled while instructions are being fetched from the instruction queue 115. Fetching of instructions from the program memory 105 may be disabled by, for example, disabling a component, e.g., an instruction fetch unit (not shown), that fetches instructions from the program memory 105. The component may be disabled by controlling the clock signal or power that is delivered to the component. When the component that fetches instructions from the program memory 105 is disabled, the total power consumed by the processing system may be reduced because there is no unnecessary fetching of instructions from the program memory 105.

In some implementations, when the last instruction of the loop routine has been fetched from the instruction queue 115 and the loop routine has been exited, fetching of instructions from the program memory 105 may be enabled again. In some implementations, when the oldest instruction in the instruction queue 115, which may be a skipped instruction or an instruction outside of the loop routine, has been fetched from the instruction queue 115 for decoding by the instruction decode unit 130, fetching of instructions from the program memory 105 may be enabled again. In some implementations, when the valid bit vector 140 indicates that the next instruction to be fetched from the instruction queue 115 is invalid, fetching of instructions from the program memory 105 may be enabled again. The next instruction fetched from the program memory 105 may be stored in the instruction queue 115 according to the FIFO principle.

In some implementations, a branch instruction or a jump instruction may direct program execution to a target instruction having a memory address that is further away from the memory address of the branch instruction or the jump instruction than the number of entries of the instruction queue 115. In some implementations, the contents of the program memory 105 may change such that the instructions in the instruction queue 115 are no longer valid instructions to be executed by the processor 100. In both instances, the entire instruction queue 115 and the valid bit vector 140 may be invalidated, and fetching of instructions from the program memory 105 may be enabled again.

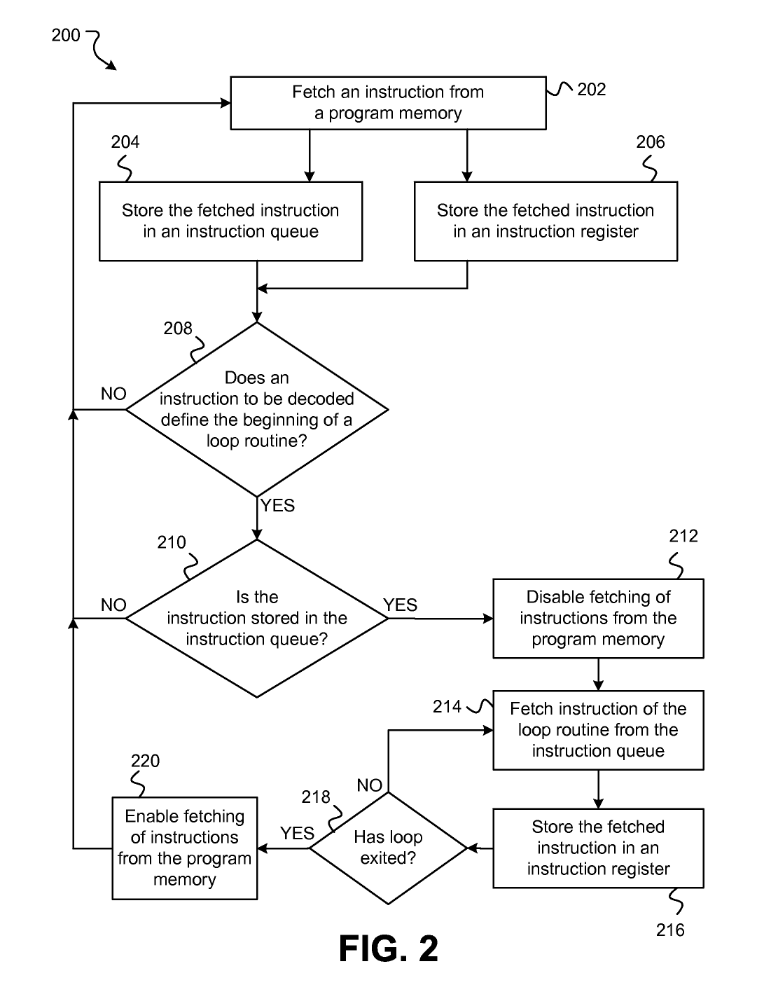

A method for controlling the fetching of instructions of a loop routine is represented in FIG. 2, which is a flowchart showing examples of operations 200 performed by a processor (e.g., the processor 100 shown in FIG. 1) while fetching instructions of a loop routine. The processor fetches instructions from a program memory at 202, and the fetched instructions are stored in an instruction queue at 204. To store a fetched instruction in the instruction queue, an entry or storage location in the instruction queue is allocated to the instruction. If the instruction queue is full, an entry or storage location associated with an instruction that has been stored in the instruction queue for the longest amount of time is deallocated before allocating an entry to the fetched instruction. The instruction and a memory address associated with the instruction are stored in the entry or storage location. In some implementations, the processor sets a valid bit of a valid bit vector corresponding to the entry to indicate that the fetched instruction is valid. The processor may store the fetched instruction in an instruction register for decoding by an instruction decode unit at 206 concurrently with storing the instruction in the instruction queue.

At 208, the processor determines whether an instruction to be decoded defines the beginning of a loop routine. The processor can perform loop detection either after the decode stage or after the execution stage. The processor may determine that the instruction to be decoded defines the beginning of a loop routine after decoding a previous instruction when, for example, the previous instruction contains syntax reflecting the ending point of a “for” or a “while” loop routine and the number of iterations of the loop routine remaining has not reached zero. The processor may determine that the instruction to be decoded defines the beginning of a loop routine after the execution stage when, for example, an executed branch or jump instruction directs program execution to a target instruction that occurs earlier in the instruction sequence. To make this determination, the processor compares a memory address specified by the result of the executed instruction with the memory address of the executed instruction. If the memory address specified by the result occurs earlier than the memory address of the executed instruction, the instruction to be decoded may define the beginning of a loop routine.

If the instruction to be decoded does not define the beginning of a loop routine, the processor returns to 202 and fetches an instruction from the program memory. If the instruction to be decoded does define the beginning of a loop routine, the processor determines whether the instruction is stored in the instruction queue at 210.

In some implementations, the processor may make this determination by searching the instruction queue for the memory address of the instruction by, for example, comparing the memory address of the instruction with the memory addresses specified in the entries of the instruction queue. If the memory address of the instruction matches a memory address specified in an entry of the instruction queue, the instruction is stored in the instruction queue.

In some implementations, the processor may make this determination by checking a valid bit of the valid bit vector at an offset position indicated by a branch or jump instruction. If the valid bit of the valid bit vector at the offset position indicates that the instruction is valid, the instruction is stored in the instruction queue.

If the processor determines that the instruction defining the beginning of the loop routine is not stored in the instruction queue, the processor determines that at least some of the instructions of the loop routine are not stored in the instruction queue. When the processor determines that at least some of the instructions of the loop routine are not stored in the instruction queue, the processor returns to 202 and fetches the instruction from the program memory.

If the processor determines that the instruction defining the beginning of the loop routine is stored in the instruction queue, the processor may determine that all of the instructions of the loop routine are stored in the instruction queue. When the processor determines that the instructions of the loop routine are stored in the instruction queue, the processor disables fetching of instructions from the program memory at 212. The processor fetches the instruction of the loop routine from the instruction queue at 214 and stores the instruction in an instruction register at 216 for decoding by the instruction decode unit. In some implementations, before fetching each instruction of the loop routine from the instruction queue, the processor may check the valid bit vector to determine whether the instruction queue is storing a valid instruction. When the loop routine has been exited at 218, the processor may enable fetching of instructions from the program memory at 220 and return to fetching an instruction from the program memory at 202.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially as claimed as such, one or more features from a claimed combination can in some cases be excised from the combination, and the claimed combination may be directed to a subcombination or variation of a subcombination.

What is claimed is:

1. A method comprising:
storing instructions fetched from a program memory in an instruction queue;
determining that an instruction to be decoded defines a beginning of a loop routine;
determining whether the instruction is stored in the instruction queue;
in response to determining that the instruction is stored in the instruction queue:
disabling fetching of instructions from the program memory,
fetching instructions of the loop routine from the instruction queue, and
storing the instructions of the loop routine in an instruction register; and
in response to determining that the instruction is not stored in the instruction queue:
fetching the instruction from the program memory,
storing the instruction in the instruction queue, and
storing the instruction in the instruction register.

2. The method of claim 1, wherein storing instructions fetched from the program memory in the instruction queue comprises:
storing instructions fetched from the program memory in a first in, first out (FIFO) queue.

3. The method of claim 1, wherein storing instructions fetched from the program memory in the instruction queue comprises:
storing instructions that are skipped as a result of a branch or a jump.

4. The method of claim 1, wherein determining that the instruction to be decoded defines the beginning of the loop routine comprises:
determining that a decoded instruction defines an ending point of the loop routine; and
determining that a number of iterations of the loop routine remaining has not reached zero.

5. The method of claim 1, wherein determining that the instruction to be decoded defines the beginning of the loop routine comprises:
receiving a memory address associated with a result of an executed instruction; and
determining that the memory address occurs earlier than a memory address associated with the executed instruction.

6. The method of claim 1, wherein in response to determining that the instruction is stored in the instruction queue, the method further comprises:
determining that the loop routine has been exited; and
re-enabling fetching of instructions from the program memory.

7. The method of claim 1, wherein in response to determining that the instruction is not stored in the instruction queue, storing the instruction in the instruction queue and storing the instruction in the instruction register comprises storing the instruction in the instruction register concurrently with the storing of the instruction in the instruction queue.

8. An apparatus comprising:
an instruction queue;
an instruction register; and
a controller configured to:
store instructions fetched from a program memory in the instruction queue;
determine that an instruction to be decoded defines a beginning of a loop routine;
determine whether the instruction is stored in the instruction queue;
in response to determining that the instruction is stored in the instruction queue:
disable fetching of instructions from the program memory,
fetch instructions of the loop routine from the instruction queue, and
store the instructions of the loop routine in the instruction register; and
in response to determining that the instruction is not stored in the instruction queue:
fetch the instruction from the program memory,
store the instruction in the instruction queue, and
store the instruction in the instruction register.

9. The apparatus of claim 8, wherein the controller is configured to store instructions fetched from the program memory in a first in, first out (FIFO) queue.

10. The apparatus of claim 8, wherein the controller is configured to store instructions that are skipped as a result of a branch or a jump.

11. The apparatus of claim 8, wherein the controller is configured to:
determine that a decoded instruction defines an ending point of the loop routine; and
determine that a number of iterations of the loop routine remaining has not reached zero.

12. The apparatus of claim 8, wherein the controller configured to:
receive a memory address associated with a result of an executed instruction; and
determine that the memory address occurs earlier than a memory address associated with the executed instruction.

13. The apparatus of claim 8, wherein in response to determining that the instruction is stored in the instruction queue, the controller is further configured to:
determine that the loop routine has been exited; and
re-enable fetching of instructions from the program memory.

14. The apparatus of claim 8, wherein in response to determining that the instruction is not stored in the instruction queue, the controller is configured to store the instruction in the instruction register concurrently with the storing of the instruction in the instruction queue.

15. A system comprising:
a program memory; and
a processor configured to:
store instructions fetched from the program memory in an instruction queue;
determine that an instruction to be decoded defines a beginning of a loop routine;
determine whether the instruction is stored in the instruction queue;
in response to determining that the instruction is stored in the instruction queue:
disable fetching of instructions from the program memory,
fetch instructions of the loop routine from the instruction queue, and
store the instructions of the loop routine in an instruction register; and
in response to determining that the instruction is not stored in the instruction queue:
fetch the instruction from the program memory,
store the instruction in the instruction queue, and
store the instruction in the instruction register.

16. The system of claim 15, wherein the processor is configured to store instructions fetched from the program memory in a first in, first out (FIFO) queue.

17. The system of claim 15, wherein the processor is configured to store instructions that are skipped as a result of a branch or a jump.

18. The system of claim 15, wherein the processor is configured to:
determine that a decoded instruction defines an ending point of the loop routine; and
determine that a number of iterations of the loop routine remaining has not reached zero.

19. The system of claim 15, wherein the processor is configured to:
receive a memory address associated with a result of an executed instruction; and
determine that the memory address occurs earlier than a memory address associated with the executed instruction.

20. The system of claim 15, wherein in response to determining that the instruction is stored in the instruction queue, the processor is further configured to:
determine that the loop routine has been exited; and
re-enable fetching of instructions from the program memory.

21. The system of claim 15, wherein in response to determining that the instruction is not stored in the instruction queue, the processor is configured to store the instruction in the instruction register concurrently with the storing of the instruction in the instruction queue.
